(19) United States
(12) Patent Application Publication
(10) Pub. No.: US 2005/0238233 A1
(43) Pub. Date: Oct. 27, 2005

(54) Computation of contour

(76) Inventors: Miguel Mulet Parada, Oxford (GB); Jacques Feldmar, Oxford (GB); Jerome Marie Joseph Declerck, Oxford (GB)

Correspondence Address: WENDEROTH, LIND & PONACK, L.L.P., 2033 K STREET N. W., SUITE 800, WASHINGTON, DC, 20006-1021, US

(21) Appl. No.: 10/525,005

(22) PCT Filed: Aug. 18, 2003
(86) PCT No.: PCT/GB03/03585

§ 371 Date: Feb. 17, 2005

(30) Foreign Application Priority Data
Aug. 20, 2002 (GB) 0219408.2

(51) Int. Cl. G06K 9/48; G06K 9/00

(52) U.S. Cl. 382/199; 382/128

(57) ABSTRACT

A method of computing a contour, such as the endocardial boundary in an ultrasound long-axis view of the heart, is disclosed. A plurality of points are input, each point being indicative of a predetermined landmark point in the image. A preliminary contour is then derived based on the input points and a known average contour shape which has been obtained from a database of contours derived from previous images. Finally, the preliminary contour is deformed to fit features identified in the image by a feature-extraction algorithm, to obtain the computed contour.

The present invention relates to the computation of a contour, for example representing the outline of an item of interest in an image.

A number of different techniques, also known as modalities, are now available for creating medical images, for example tomographic images of the heart. The left ventricle of the heart is the main pump which circulates oxygenated blood around the body. Disorder and malfunction of the left ventricle is the main fatal disease in western developed countries. Therefore assessment of the functioning of the left ventricle has become of major importance.

Previously, one technique was to obtain images showing the heart moving over a number of heart beats. These images are analysed by a cardiologist who knows how to diagnose some diseases from a careful observation of the motion in the images. Clearly this technique is time-consuming and depends on the skill and experience of the cardiologist.

Other techniques attempt to analyse and quantify the performance of the heart by identifying and tracking the motion of, for example, the endocardial boundary of the left ventricle, i.e. the inner periphery of the wall of the left ventricle. Typically the boundary is modelled as a smooth contour and the functional assessment would be based on the analysis of the shape and the motion of the contour only.

One method of identifying the contour is to manually trace the boundary in the image. This has the problems of being reliant on the skill of the user and is time-consuming if it has to be performed on many images. If the contour is to be accurate then a lot of points must be input.

Another technique which improves on this is to input fewer points on the boundary, such as ten points which approximately trace the contour, then a computer is used to fit a spline to the inputted points. Finally, known image processing techniques are used to identify significant features in the image, including those corresponding to the desired boundary, and an optimization technique is used to adjust the spline to fit the boundary features in the image. Again, this technique suffers from the problems that, for it to work, a relatively large number of points must be input, and the final identified contour does not necessarily bear any relationship to the real-life anatomical properties of the item it represents, such as the left ventricle.

Yet another technique is to create a database of known shapes of the item to be identified and to create a statistical model of the deformation of the shape. Image analysis is applied to the image to identify significant features and finally an optimization routine is used to find in the image the best contour which is a compromise between the identified features and the statistical shape model. Further information on this method can be found in T. F. Cootes and C. J. Taylor “Statistical models of appearance for medical image analysis and computer vision”, Proc. SPIE Medical Imaging 2001; Image Processing, Volume 4322, Editors Milan Sonka and Kenneth M. Hanson, July 2001, pp 236-248. This method suffers from the problem that there is no information on how to initialise the search for the optimum contour in the image.

It is therefore an object of the invention to provide a technique for computation of a contour which alleviates, at least partially, any of the above problems.

Accordingly, the present invention provides a method of computing a contour comprising the steps of:
inputting a plurality of points, each point being indicative of a predetermined landmark point in an image;
deriving a preliminary contour based on the input points and a known average contour shape; and
deforming the preliminary contour to fit features identified in the image to obtain the computed contour.

The fact that the inputted points are indicative of predetermined landmark points means that the contour finding process is initialised and improves the preliminary contour. The use of a preliminary contour based on a known average contour shape means that it is necessary to input fewer points than previously because the derived contour will always be based on a known shape, and therefore, in the case of anatomical images enables the contour to be anatomically correct.

The use of a priori knowledge of the average shape of the contour of the item of interest and the fact that the input points are know to correspond to specific landmarks, enables the number of input points to be far fewer than the number needed to define the shape of the computed contour, and the points do not have to be input specifically at regions of high curvature.

Preferably the number of inputted points is fewer than the number of points needed to define the shape of the computed contour.

Preferably the number of degrees of freedom defined by the inputted points is fewer than the number of degrees of freedom needed to define the shape of the computed contour.

For computing a contour, there are basically 2 degrees of freedom per input point. According to preferred embodiments of the invention, to define the shape of the final computed contour might require approximately 20 degrees of freedom, but the invention can achieve this using only, for example, 3 input points i.e. 6 degrees of freedom. In more detail, the number of degrees of freedom is related to the amount of information required from a user to obtain the contour of a desired shape. For instance, it might take 10 points to achieve a visually acceptable contour using a standard parametric curve (e.g. linear interpolation between points, or a low-degree B-spline, such as quadratic or cubic, which is an extension of linear interpolation to a piecewise polynomial curve). These parametric curves are very commonly used, for example in graphics software for drawing free-form curves. A piecewise linear is a very simplistic curve in the sense that in order to define the location anywhere along the curve you just need to know the 2 closest nodes (points) along the curve and draw a straight line between them. For a B-spline, it is not the 2 closest, but the 3 or 4 closest (for quadratic and cubic, respectively), so it is only slightly more sophisticated. However, the present invention is much more sophisticated because there is a lot more information about the shape of the curve inside the definition of the curve itself: this is what enables the user to input a minimal number of points. It is not necessary for the user to input all the information on the shape of the curve, e.g. by clicking a mouse at many points along the curve; instead much of the information is already stored in advance in the form of, for example, the average contour shape and a statistical shape model obtained from a database of known contours. Thus the invention enables the user to input only a few specific points to define the desired contour, and fewer points than would be required to define that contour from scratch. With a B-spline, you can draw whatever shape you want, but it takes a lot of points (degrees of freedom) to get it right. With embodiments of the invention you can draw only specific contours, for example left ventricular endocardiae (depending on the database used), but it requires only very few input points to do so.

The deriving step may comprise applying a parametric model to transform the known average contour shape such that the landmark points of the average contour shape match the corresponding input points. Preferably the deforming step comprises deforming the preliminary contour by applying the same parametric model as in the deriving step. The known average contour shape may be obtained using a database of contours derived from other images (typically previously collected images), and the parametric model can be a deformation model derived from a statistical shape model constructed from the same database of contours derived from previous images.

Preferably the image is an anatomical image, for example a long-axis view of the heart, and the computed contour can represent the endocardial boundary of the left ventricle of the heart. In this case it is only necessary to input three points which identify the following landmarks: the root of the left mitral valve leaflet, the apex of the left ventricle, and the root of the right mitral valve leaflet.

A further aspect of the present invention provides a method of computing the motion of a contour, for a temporal sequence of images of a subject, comprising the steps of:
computing the contour for one image of the sequence according to the method described above;
using the computed contour as a new preliminary contour for a further image in the sequence;
deforming the new preliminary contour to fit features identified in the further image to obtain the computed contour for the further image; and
repeating the using and deforming steps to obtain a computed contour for each image in the sequence.

The invention may be embodied in a computer system for processing data representing an image in conjunction with input points indicative of predetermined landmark points and the invention extends to a computer program for executing the method on a programmed computer. The invention also extends to a computer program product carrying such a computer program.

Embodiments of the invention will be further described, by way of example only, with reference to the accompanying drawings in which:—

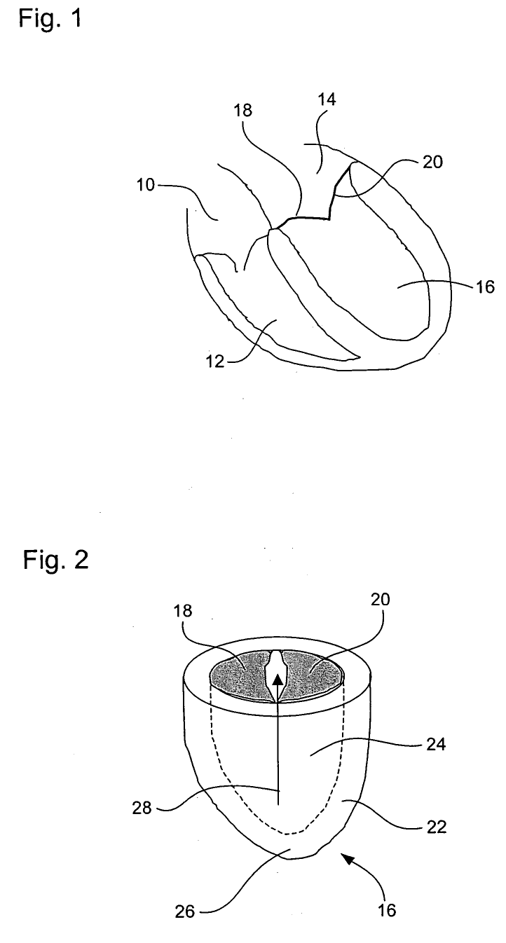

FIG. 1 is a schematic illustration of the human heart in cross-section;

FIG. 2 is a sketch of the left ventricle of the heart;

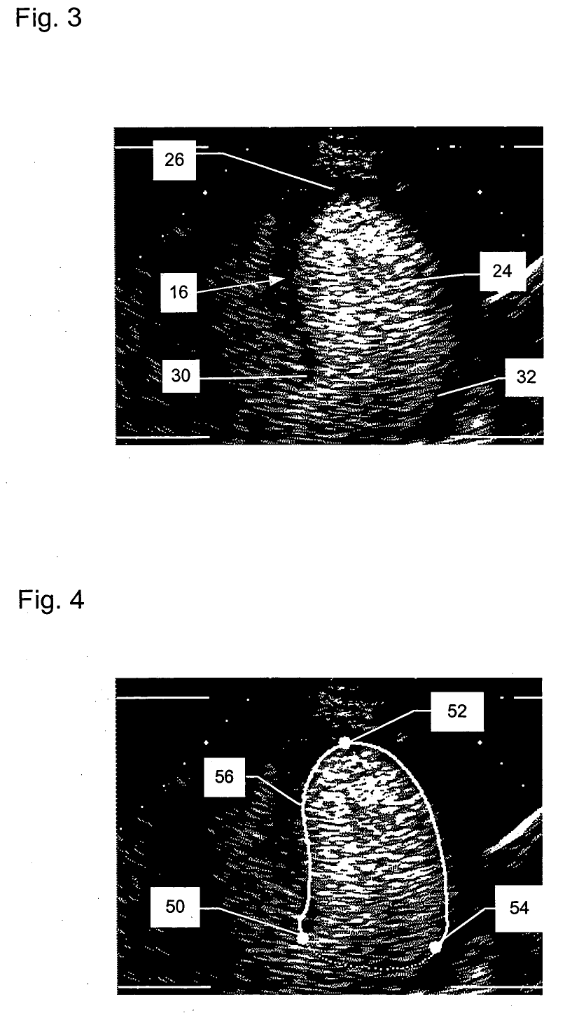

FIG. 3 is a contrast enhanced ultrasound image of a long-axis view of the heart;

FIG. 4 is the image of FIG. 3 showing three identified landmark points and a preliminary contour;

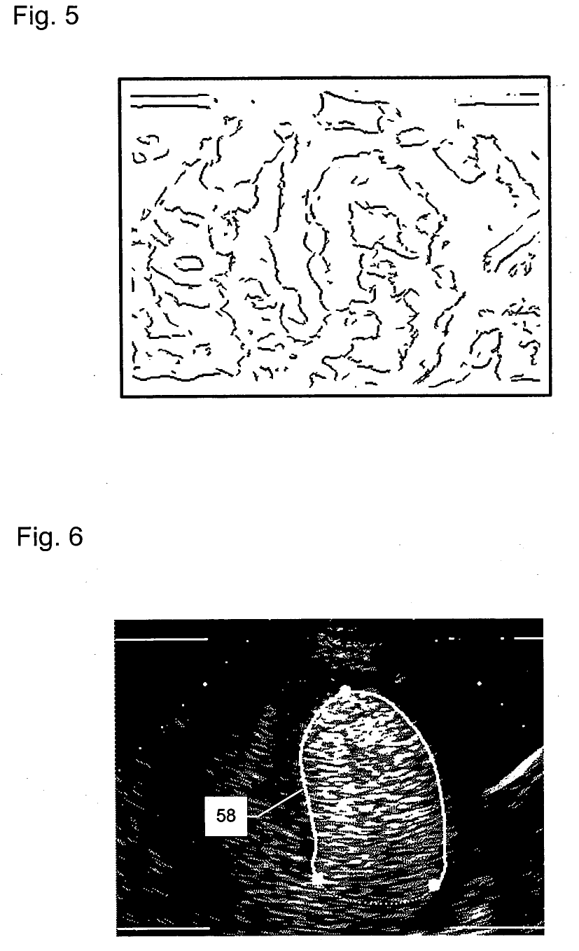

FIG. 5 illustrates a set of points corresponding to significant locations in the image of FIG. 3 extracted using a feature extraction algorithm;

FIG. 6 is the ultrasound image of FIG. 3 showing the final computed contour;

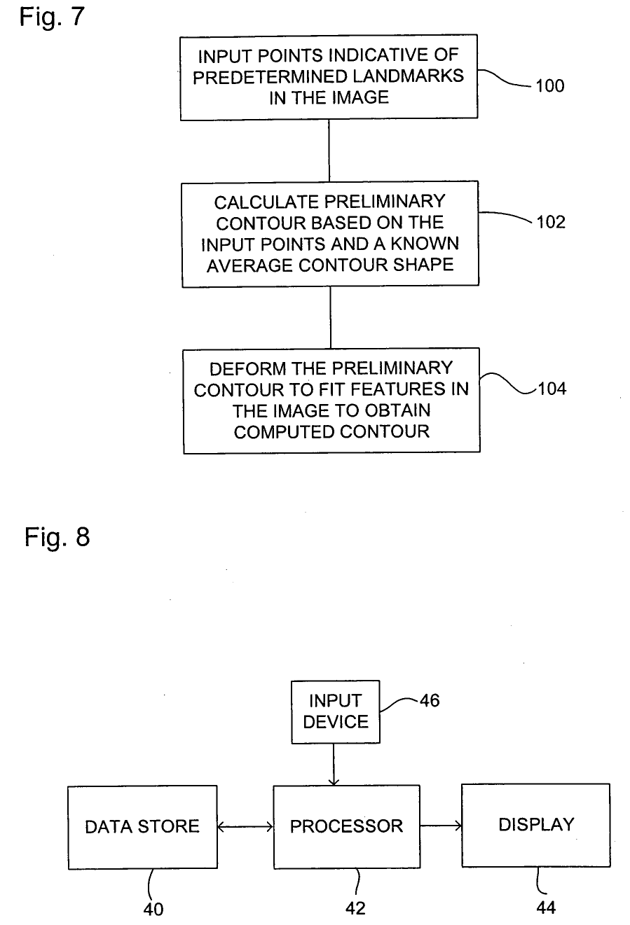

FIG. 7 is a block diagram schematically showing a computer system for implementing the invention; and

FIG. 8 is a flow diagram illustrating an embodiment of a method according to the invention.

In the different figures, corresponding parts are indicated by the same reference numerals.

Embodiments of the present invention will be described with reference to the example of computing a contour of the endocardial boundary of the left ventricle of the human heart. FIG. 1 is a sketch of the heart showing the four chambers, namely the right atrium 10, the right ventricle 12, the left atrium 14, and the left ventricle 16. Also indicated is the mitral valve of the left ventricle 16 comprising the right mitral valve leaflet 18 and the left mitral valve leaflet 20.

FIG. 2 specifically shows the left ventricle 16, the shape of which is approximately a thick cup comprising the left ventricular muscle (myocardium) 22 surrounding the left ventricular cavity 24. At the closed end of the cup-shape is the apex 26 and at the opposite end there is located the right mitral valve leaflet 18 and the left mitral valve leaflet 20. The approximate axis of rotational symmetry of the left ventricle 16 is known as the long-axis 28.

FIG. 3 is a tomographic image of the heart showing mainly the left ventricle 16. The image is a long-axis view i.e. a cross-sectional image in a plane substantially containing the long axis. The particular image in FIG. 3 is a contrast enhanced ultrasound image (echocardiogram). However, the invention can be used with images obtained by any other suitable modality, for example nuclear medicine, X-ray (fluoroscopy or ventriculography), magnetic resonance imaging and so on. The light region in the middle of the image of FIG. 3 corresponds to the left ventricular cavity 24. The image in FIG. 3 is the opposite way up to the diagram of FIG. 2 in that in FIG. 3 the apex 26 is at the top. The roots or bases of the left and right mitral valve leaflets are indicated at 30 and 32.

After data representing an image or sequence of images, such as FIG. 3, have been obtained, the method of the invention can be applied. The apparatus for performing the method of the invention does not have to be part of the apparatus for obtaining the image and does not have to be operated by a sonographer or other radiographer. The apparatus for effecting the invention can be a conventional computer system which has access to the data representing the image or images to be analysed. Of course, the apparatus can be a system dedicated for use with the imaging equipment and can be operated by a radiographer. FIG. 7 illustrates schematically a computer system for computing a contour according to an embodiment of the invention. The software for performing a method embodying the invention is stored in data store 40 and executed by processor 42. Data corresponding to the image to be analysed can also be stored in data store 40 and displayed by the processor 42 on display 44. An input device 46 enables the user to input information relating to the image on the display 44, as will be discussed in more detail below.

FIG. 8 illustrates the contour computation method in accordance with an embodiment of the present invention. Firstly, in step 100 the user inputs three points indicative of anatomical landmarks in the image. This can be conveniently done by viewing the image on the display 44 and using a mouse as the input device 46 to move a cursor on the display 44 and clicking a mouse button to input a point when the cursor is at a desired location. Any other suitable input device can be used in place of a mouse, for example a touch-sensitive screen, a stylus, a track-ball, keyboard and so on. The data representing the points could have been entered previously by an operator, and stored, such that the “inputting” step 100 merely involves the processor 42 reading the data representing the points from a store.

In the present example, the three predetermined anatomical landmarks are the root of the left mitral valve, the apex, and the root of the right mitral valve leaflet. FIG. 4 shows the three input points as the light circles indicated at 50, 52 and 54, respectively. The three points can be input very quickly just by three mouse clicks. It is not necessary for the input points to be highly accurate, for example, an input point may just be indicative of the relevant landmark and could be anywhere within, for example, 5 mm of the landmark. The process by which the contour is obtained and improved will be described below.

Next, according to step 102 of FIG. 8, a preliminary contour is derived from the positions of the three input points. The preliminary contour 56 is shown in FIG. 4. In order to generate such a contour 56 from just three points, and which contour is still anatomically plausible, a known average contour shape is used together with a parametric model of the deformation which can transform the average shape into any acceptable shape within a certain precision determined in advance. One way to do this is as follows. A database of contours is created, for example, by manually tracing the desired contour in many images, and for each contour of the database the three predetermined landmarks are identified, for instance by an expert. The process of the creation of this database can be very labour-intensive, requiring much contribution by an expert, however, the database only needs to be created once and thereafter it can be used with a method according to this invention for the analysis of an unlimited number of new images. From the database of contours, an average contour can be computed. For example the contours are normalised with respect to the variations of size and orientation of the left ventricle in the image, allowing the computation of the average shape.

Thereafter, continuing in step 102, the three landmark points of the real image and the three landmark points of the average shape contour are matched together, and a 2D similarity transformation (comprising rotation, translation and scaling) is computed. The average contour is then deformed according to this similarity transformation to derive the preliminary contour 56 as shown in FIG. 4. Further details of a way to create a statistical shape model from a database of real shapes for implementing the step just described are given in T. F. Cootes and C. J. Taylor “Statistical models of appearance for medical image analysis and computer vision”, proceedings SPIE Medical Imaging 2001; Image Processing, Volume 4322, Editors Milan Sonka and Kenneth M. Hanson, July 2001, pp 236-248. However, any other parametric model would be acceptable.

The preliminary contour 56 shown in FIG. 4 has the generic shape of the left ventricle as it appears in a typical image of the same modality, and is close to the real shape, but is not quite right.

Therefore in step 104 of the FIG. 8, the preliminary contour 56 is deformed to match or better fit features in the real image. FIG. 5 shows a set of points at significant locations in the image of FIG. 3 obtained using a feature extraction algorithm. These features were extracted using the method explained in WO 02/43004, but any feature extraction algorithm which provides a discrete set of points at significant locations in the image is suitable.

The preliminary contour obtained at step 102 is deformed using the adaptation of the iterative closest point (ICP) algorithm, for example as explained in M. Mulet Parada “Intensity independent feature extraction and tracking in echocardiographic sequences”, PhD manuscript, Oxford University, Oxford, United Kingdom, 2000. Further information on the ICP algorithm can be gleaned from J. Declerck, J. Feldmar, M. L. Goris and F. Betting “Automatic registration and alignment on a template of cardiac stress and rest SPECT images”, IEEE Transactions on Medical Imaging 16(6):727-737, December 1997. The transformation model which is used to deform the preliminary contour 56 can be, for example simple radial basis functions, or B-splines tensor product as in the reference by Declerck, Feldmar, Goris and Betting cited above, or preferably the same deformation model derived from a statistical shape model constructed from the contour database as explained above with reference to step 102 and in the publication by Cootes and Taylor. FIG. 6 shows the computed contour 58 obtained as the result of step 104. The deformation of the preliminary contour 56 to obtain the computed contour 58 in step 104 is not constrained to the original three input points and hence the accuracy of the computed contour 58 is not dependent on the accuracy of the three input points, provided that the three input points are approximately in the vicinity of the predetermined landmark points in the image.

The computed contour 58 can be used as the basis for an automatic calculation of a single-plane estimate of the left ventricle volume using conventional integration techniques, such as a modified Simpson's rule or the method of discs. From an end diastolic image (i.e. at the end of cardiac relaxation), the end diastolic volume EDV can be obtained, and from an end systolic image (i.e. at the end of cardiac contraction), the end systolic volume ESV can be calculated. The difference between these volumes i.e. EDV minus ESV gives the stroke volume which is the estimated amount of blood ejected by the left ventricle, and the stroke volume divided by the end diastolic volume EDV gives the ejection fraction. The stroke volume and ejection fraction are important parameters in the assessment of the function of the heart of a patient.

Typically a sequence of images is obtained at intervals of approximately one tenth of a second showing the heart, and in particular the left ventricle, moving over one or more heat beats. In analysing such a sequence according to a further embodiment of the invention, it is not necessary for the user to input the landmark points for every image in the sequence. In fact, the three landmark points can be input for just one image in the sequence which is then used to obtain a computed contour according to a method of FIG. 8 as described above. The computed contour can then be tracked through the image in each frame of the sequence, for example as described in WO 02/43004, or for example, the computed contour could be used as a preliminary contour for repeating step 104 for each of the other images or using a contour computed for the image of one frame as the preliminary contour for the image of an adjacent frame and iterating through the sequence.

After the contour has been computed for each frame, an estimate of the ventricle volume can be calculated for each frame and the maximum volume set as the end diastolic volume and the minimum volume in a sequence set as end systolic volume, and from these the ejection fraction and stroke volume can be calculated. This process can be entirely automated, such that for a sequence of images, just by performing a mouse click approximately at each of three landmark points in one image, the ejection fraction and stroke volume can be obtained without any further user input.

Although the embodiments described above have been in terms of the human heart, this is purely by way of example, and the method of the invention can be applied to other organs, such as the brain or liver, in which case a different set of predetermined landmarks would be used, and the number of landmark points would not necessarily be three. Any desired modality could also be used. The technique can be used with views of the heart other than the long-axis view, and again different landmarks would be determined in advance. The embodiments described above have given the example of computing a contour in 2 dimensions, but the invention is not limited to 2D and can be used in further dimensions such as 3D.

The invention is also not limited to obtaining contours in anatomical or medical images and could equally be used in other fields, such as assisted object recognition, such as of vehicles or aircraft, fingerprinting, assisted segmentation of buildings in satellite image processing and so on.

1. A method of computing a contour comprising the steps of:
inputting a plurality of points, each point being indicative of a predetermined landmark point in an image;
deriving a preliminary contour based on the input points and a known average contour shape; and
deforming the preliminary contour to fit features identified in the image to obtain the computed contour.

2. A method according to claim 1, wherein the number of inputted points is fewer than the number of points needed to define the shape of the computed contour.

3. A method according to claim 1, wherein the number of degrees of freedom defined by the inputted points is fewer than the number of degrees of freedom needed to define the shape of the computed contour.

4. A method according to claim 1, wherein the known average contour shape is obtained using a database of contours derived from previous images.

5. A method according to claim 1, wherein the deriving step comprises applying a parametric model to transform the known average contour shape such that the landmark points of the average contour shape match the corresponding input points.

6. A method according to claim 5, wherein the deforming step comprises deforming the preliminary contour by applying the same parametric model as in the deriving step.

7. A method according to claim 5, wherein the parametric model is a deformation model derived from a statistical shape model constructed from a database of contours derived from previous images.

8. A method according to claim 1, wherein the contour represents the boundary of an item of interest in the image.

9. A method according to claim 1, wherein the image is an anatomical image.

10. A method according to claim 9, wherein the image is an image of the heart.

11. A method according to claim 10, wherein the image is a long-axis view of the heart.

12. A method according to claim 10, wherein the contour represents the endocardial boundary of the left ventricle of the heart.

13. A method according to claim 12, further comprising the step of calculating the volume of the left ventricle.

14. A method according to claim 1, wherein the predetermined landmark points in the image comprise: the root of the left mitral valve leaflet, the apex of the left ventricle, and the root of the right mitral valve leaflet.

15. A method according to claim 1, wherein the number of inputted points is exactly three.

16. A method according to claim 1, wherein the image is an image created using a modality selected from the group consisting of ultrasound, nuclear medicine, X-ray and magnetic resonance imaging.

17. A method of computing the motion of a contour, for a temporal sequence of images of a subject, comprising the steps of:
computing the contour for one image of the sequence according to the method of anyone of the preceding claims;
using the computed contour as a new preliminary contour for a further image in the sequence;
deforming the new preliminary contour to fit features identified in the further image to obtain the computed contour for the further image; and
repeating the using and deforming steps to obtain a computed contour for each image in the sequence.

18. A method according to claim 17, wherein the computed contours represent the endocardial boundary of the left ventricle of the heart, further comprising the steps of: calculating left ventricle volumes from the computed contours; using the calculated volumes to calculate at least one of the stroke volume and ejection fraction of the heart.

19. A computer system comprising a data processor, a data storage means, input device and a display, the data processor being adapted to process data in accordance with an executable program stored in the data storage means, wherein the executable program is adapted to execute the method of any one of the preceding claims on data representing the image displayed on the display and using the plurality of points indicative of predetermined landmark points in the image input with the input device.

20. A computer program comprising program code means for executing on a computer the method of claim 1.

21. A computer program product carrying the computer program of claim 20.

22. A method according to claim 11, wherein the contour represents the endocardial boundary of the left ventricle of the heart.

23. A method according to claim 22, further comprising the step of calculating the volume of the left ventricle.
